(19) United States
(12) Patent Application Publication
(10) Pub. No.: US 2012/0062419 A1
(43) Pub. Date: Mar. 15, 2012

(54) APPARATUS AND METHOD FOR ANALYZING RADIO WAVE PROPAGATION IN RADIO WAVE SYSTEM

(75) Inventor: Young-Keun Yoon, Cheongju-si (KR)

(73) Assignee: ELECTRONICS AND TELECOMMUNICATIONS RESEARCH INSTITUTE, Daejeon (KR)

(21) Appl. No.: 13/008,339

(22) Filed: Jan. 18, 2011

(30) Foreign Application Priority Data
Sep. 9, 2010 (KR) 10-2010-0088436

(51) Int. Cl. H01Q 3/00

(52) U.S. Cl. 342/360

(57) ABSTRACT

An apparatus for analyzing radio wave propagation in a radio wave system includes: an identification unit configured to search and identify all objects existing in a service area in which users are provided with services; a construction unit configured to calculate a relative position between the identified objects and acquire a radio wave propagation model based on visibility at respective objects; and an analysis unit configured to apply the radio wave propagation model to ray tracing dynamically and analyze radio wave propagation in the service area.

### CROSS-REFERENCE(S) TO RELATED APPLICATIONS

The present application claims priority of Korean Patent Application No. 10-2010-0088436, filed on Sep. 9, 2010, which is incorporated herein by reference in its entirety.

### BACKGROUND OF THE INVENTION

1. Field of the Invention

Exemplary embodiments of the present invention relate to a radio wave system; and, more particularly, to an apparatus and a method for analyzing and predicting the radio wave propagation environment by using a ray tracing scheme efficiently.

2. Description of Related Art

Recently, increasing demands for various types of communication and broadcasting services, including personal communication services, are followed by increasing interests in the radio wave propagation environment of the service area, i.e. region where a service is to be provided. Specifically, in order to provide users with a high-speed service accurately and stably in the service area, the radio wave propagation environment of the service area needs to be analyzed an predicted more accurately.

In an attempt to analyze and predict the radio wave propagation environment, schemes for acquiring, analyzing, and predicting a radio wave propagation model based on radio wave propagation paths have been proposed, a typical example of which is a ray tracing scheme. The ray tracing scheme includes an electro-image method and a ray launching method.

A radio wave propagation model, which is applied to the ray tracing scheme in order to analyze and predict the radio wave propagation environment, is acquired by obtaining statistics of experiment results, or by predicting propagation paths theoretically using computers. The statistics-based approach makes it possible to easily acquire radio wave propagation prediction values, but the accuracy of the radio wave propagation model is limited due to the absence of consideration of actual topography and building distribution in the service area. The computer-based approach can acquire a very accurate radio wave propagation model by calculating every possible radio wave propagation path based on data regarding actual buildings in the service area, but such calculation of as many radio wave propagation paths as possible takes a long time.

The above-mentioned approaches to acquire radio wave propagation models also have the following problems: The more structures (e.g. buildings) exist in the service area, the poorer the accuracy of a radio wave propagation model acquired from statistics becomes; and, in the case of the computer-based approach, the longer it takes to calculate the increased radio wave propagation paths. Furthermore, the above-described approaches need to generate a source-based tree to acquire a radio wave propagation model. This increases the degree of complexity and the amount of calculation (i.e. redundant calculation). The speed of analysis and prediction also degrades seriously when analyzing and predicting the environment of radio wave propagation, specifically characteristics.

Therefore, there is a need for a method for acquiring a radio wave propagation model while minimizing the degree of complexity and the amount of calculation and, by applying the radio wave propagation model to a ray tracing scheme, analyzing and predicting the radio wave propagation environment rapidly and accurately.

### SUMMARY OF THE INVENTION

An embodiment of the present invention is directed to an apparatus and a method for analyzing radio wave propagation in a radio wave system.

Another embodiment of the present invention is directed to an apparatus and a method for acquiring a radio wave propagation model while minimizing the degree of complexity and the amount of calculation in a radio wave system.

Another embodiment of the present invention is directed to an apparatus and a method for analyzing radio wave propagation, which are efficiently applied to a ray tracking scheme efficiently in a radio wave system.

Still another embodiment of the present invention is directed to an apparatus and a method for analyzing and predicting the radio wave propagation environment rapidly and accurately by applying a radio wave propagation model to a ray tracing scheme in a radio wave system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for analyzing radio wave propagation in a radio wave system includes: an identification unit configured to search and identify all objects existing in a service area in which users are provided with services; a construction unit configured to calculate a relative position between the identified objects and acquire a radio wave propagation model based on visibility at respective objects; and an analysis unit configured to apply the radio wave propagation model to ray tracing dynamically and analyze radio wave propagation in the service area.

In accordance with another embodiment of the present invention, a method for analyzing radio wave propagation in a radio wave system includes: searching and identifying all objects existing in a service area in which users are provided with services; calculating a relative position between the identified objects and constructing an inter-object visibility set as a radio wave propagation model based on visibility at respective objects; generating a ray path searching structure by forming a ray path between respective objects using the inter-object visibility set; and analyzing the radio wave propagation in the service area by applying the radio wave propagation model dynamically to ray tracing through backward ray tracing based on the ray path searching structure.

### BRIEF DESCRIPTION OF THE DRAWINGS

FIG. 1 illustrates a schematic structure of an apparatus for analyzing radio wave propagation in a radio wave system in accordance with an embodiment of the present invention.

FIG. 2 illustrates an IVS constructed by an apparatus for analyzing radio wave propagation in a radio wave system in accordance with an embodiment of the present invention.

FIG. 3 illustrates a ray path searching structure generated by an apparatus for analyzing radio wave propagation in a radio wave system in accordance with an embodiment of the present invention.

FIG. 4 illustrates a schematic operation process of an apparatus for analyzing radio wave propagation in a radio wave system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention is directed to an apparatus and a method for analyzing and predicting the characteristics of radio wave propagation environments in a radio wave system. In accordance with an embodiment of the present invention, in order to provide users with various types of high-speed services stably, characteristics of radio wave propagation environments in a service area, where users are provided with services, are analyzed and predicted.

In accordance with an embodiment of the present invention, a radio wave propagation model for analyzing and predicting radio wave propagation environments is acquired with minimized degree of complexity and amount of calculation. The radio wave propagation model is constructed using an IVS (Inter-object Visibility Set) obtained by considering all objects existing in a service area, e.g. structures related with actual topography and building distribution. As used herein, the visibility means that when viewing, from a surface of an object, a surface of another object, a part or entire surface of the latter object is directly visible. For example, when the object is a figure, specifically a polygon (e.g. triangle or quadrilateral), the visibility means that when viewing, from a surface of a polygon, a surface of another polygon, the surface of the latter polygon is visible. The IVS reduces the degree of complexity and avoids redundant calculation because no tree is generated based on a source, i.e. transmission point or image point, thereby minimizing the degree of complexity and the amount of calculation when acquiring a radio wave propagation model.

Furthermore, in accordance with an embodiment of the present invention, the IVS is applied to a ray tracing scheme, e.g. 3D ray tracing scheme, to analyze and predict the radio wave propagation environment rapidly and accurately. Specifically, application of the IVS to a ray tracing scheme guarantees that the ray tracing scheme is used efficiently to analyze and predict the radio wave propagation environment. In accordance with an embodiment of the present invention, an IVS is constructed by considering all objects existing in a service area, and the constructed IVS is used to generate a ray path searching structure for analyzing the radio wave propagation environment. Based on the ray path searching structure generated in this manner, the radio wave propagation environment is analyzed and predicted through backward ray tracing.

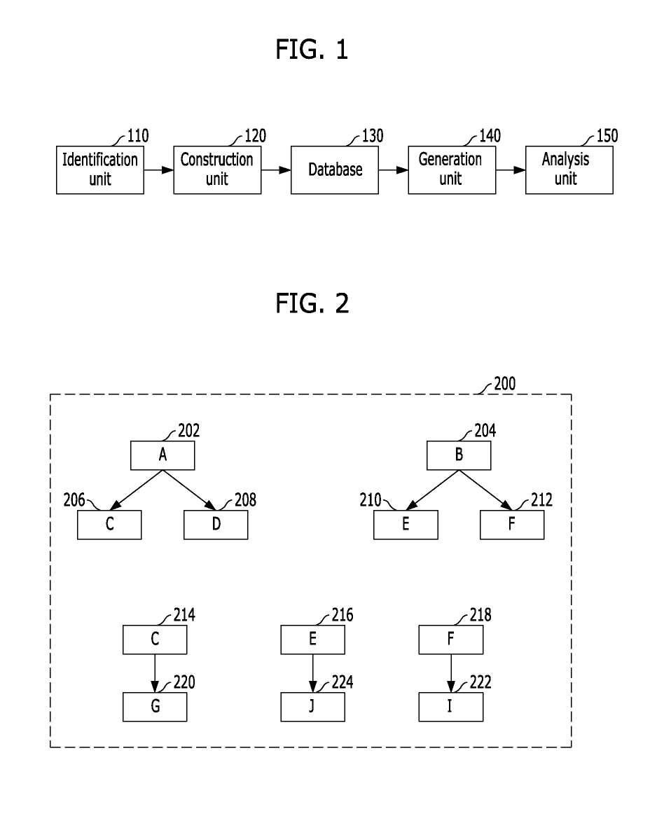

That is, in accordance with an embodiment of the present invention, when radio rave propagation environment is analyzed using a ray tracing scheme, specifically, when using a ray tracing scheme utilizing a ray viewing volume based on an electro-image method, the relative position between respective objects (structures) existing in the service area is calculated, prior to applying the above-mentioned ray tracing scheme, so as to construct a visibility set database, e.g. IVS, in order to improve the speed and accuracy of radio wave propagation environment analysis. The constructed IVS is dynamically applied to the ray tracing scheme to analyze and predict the radio wave propagation environment. Such a dynamic visibility set link, i.e. IVS, improves the speed and accuracy of the ray tracing scheme, and thus the speed and accuracy of the radio wave propagation environment analysis. An apparatus for analyzing radio wave propagation in a radio wave system in accordance with an embodiment of the present invention will now be described in more detail with reference to FIG. 1.

FIG. 1 illustrates a schematic structure of an apparatus for analyzing radio wave propagation in a radio wave system in accordance with an embodiment of the present invention.

Referring to FIG. 1, the apparatus for analyzing radio wave propagation includes an identification unit 110 configured to detect and identify all objects, i.e. structures related to actual topography and buildings existing in a service area where users are provided with various types of services; a construction unit 120 configured to calculate the relative position between all objects identified by the identification unit 110 and construct an IVS based on visibility at respective objects; a database 130 configured to store the IVS constructed by the construction unit 120; a generation unit 140 configured to generate a ray tracing searching structure for analyzing the radio wave propagation environment using the constructed IVS; and an analysis unit 150 configured to analyze and predict the radio wave propagation environment through backward ray tracing, specifically using a ray tracing scheme to which the IVS is applied, based on the ray tracing searching structure generated by the generation unit 140.

The construction unit 120 is configured to acquire a radio wave propagation model for analyzing and predicting the radio wave propagation environment, as mentioned above, with minimized degree of complexity and amount of calculation by constructing an IVS based on consideration of all objects existing in the service area, e.g. structured related to actual topography and building distribution. The construction unit 120 is configured to construct the IVS based on visibility at respective objects, i.e. visibility meaning that when viewing, from a surface of an object, a surface of another object, a part or entire surface of the latter object is directly visible. For example, when the objects existing in the service area are figures, specifically polygons (e.g. triangles or quadrilaterals), the construction unit 120 checks the visibility by viewing, from a surface of a polygon, a surface of another polygon and, if a part or the entire surface of the latter polygon is directly visible, confirms the visibility. In this manner, the construction unit 120 constructs an IVS by forming a dynamic visibility set link between objects having visibility. Such an IVS constructed by the construction unit 120 will be described later in more detail with reference to FIG. 2.

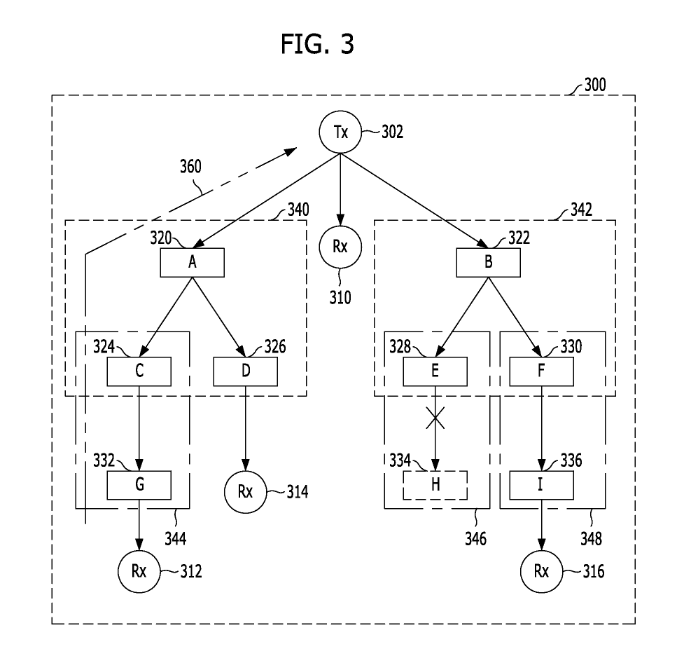

The generation unit 140 is configured to generate a ray path searching structure using the IVS in order to apply the constructed IVS to a ray tracing scheme and analyze the radio wave propagation environment. Such a ray path searching structure generated by the generation unit 140 will be described later in more detail with reference to FIG. 3.

The analysis unit 150 is configured to analyze and predict the radio wave propagation environment by applying the constructed IVS to a ray tracing scheme, specifically applying it to a 3D ray tracing scheme dynamically. The analysis unit 150 is configured to apply the constructed IVS to a ray tracing scheme, which employs a ray viewing volume based on an electro-image method, and analyze and predict the radio wave propagation environment rapidly and accurately. The analysis unit 150 is configured to analyze and predict the radio wave propagation environment through backward ray tracing based on the ray path searching structure generated by the generation unit 140. An IVS constructed by the generation unit 120 of the apparatus for analyzing radio wave propagation in accordance with an embodiment of the present invention will now be described in more detail with reference to FIG. 2.

FIG. 2 illustrates an IVS constructed by an apparatus for analyzing radio wave propagation in a radio wave system in accordance with an embodiment of the present invention. Specifically, FIG. 2 illustrates an exemplary IVS as a radio wave propagation model acquired to analyze and predict the radio wave propagation environment by the apparatus for analyzing radio wave propagation.

Referring to FIG. 2, the identification unit 110 of the apparatus for analyzing radio wave propagation identifies all objects existing in the service area, specifically objects A to J 202, . . . , 224. The construction unit 120 acquires a radio wave propagation model for analyzing and predicting the radio wave propagation environment, as mentioned above, with minimized degree of complexity and amount of calculation and constructs an IVS 200 by considering the objects A to J 202, . . . , 224 existing in the service area based on the radio wave propagation model. When the objects A to J 202, . . . , 224 are quadrilaterals, the construction 120 views, from a surface of each of the quadrilateral objects A to J 202, . . . , 224, a surface of another object and, if a part or entire surface of the latter object is directly visible, confirms the visibility. The IVS 200 is constructed through this process.

More specifically, the construction unit 120 views, from a surface of quadrilateral object A 202, another object and, when a part or entire surface of object C 206 and object D 208 is visible, confirms that object C 206 and object D 208 have visibility at object A 202, in other words, object A 202 has visibility with regard to object C 206 and object D 208. Consequently, the construction unit 102 forms a dynamic visibility set link (hereinafter, referred to as IVS-A) between object A 202 and object C 206 and object D 208. Similarly, the construction unit 120 views, from a surface of quadrilateral object B 204, another object and, when a part or entire surface of object E 210 and object F 212 is visible, confirms that object E 210 and object F 212 have visibility at object B 204, in other words, object B 204 has visibility with regard to object E 210 and object F 212. Consequently, the construction unit 120 forms a dynamic visibility set link (hereinafter, referred to as IVS-B) between object B 204 and object E 210 and object F 212.

The construction unit 120 views, from a surface of quadrilateral object C 214, another object and, when a part or entire surface of object G 220 is visible, confirms that object G 220 has visibility at object C 214, in other words, object C 214 has visibility with regard to object G 220. Consequently, the construction unit 120 forms a dynamic visibility set link (hereinafter, referred to as IVS-C) between object C 214 and object G 220. The construction unit 120 views, from a surface of quadrilateral object E 216, another object and, when a part or entire surface of object J 224 is visible, confirms that object J 224 has visibility at object E 216, in other words, object E 216 has visibility with regard to object J 224. Consequently, the construction unit 120 forms a dynamic visibility set link (hereinafter, referred to as IVS-E) between object E 216 and object J 224. The construction unit 120 views, from a surface of quadrilateral object F 218, another object and, when a part or entire surface of object I 222 is visible, confirms that object I 222 has visibility at object F 218, in other words, object F 218 has visibility with regard to object I 222. Consequently, the construction unit 120 forms a dynamic visibility set link (hereinafter, referred to as IVS-F) between object F 218 and object I 222.

As such, the construction unit 120 forms dynamic visibility set links between objects based on the visibility at every object existing in the service area and constructs an IVS 200 based on the formed dynamic visibility set links, and the IVS 200 becomes a radio wave propagation model for analyzing and predicting the radio wave propagation environment. The IVS 200 constructed in this manner reduces the degree of complexity and avoids redundant calculation because no tree is generated based on a source, i.e. transmission point or image point, thereby minimizing the degree of complexity and the amount of calculation when acquiring a radio wave propagation model. It is to be noted that when, from a surface of an object, another object is viewed, a part or entire surface of the latter object is visible, and then a dynamic visibility set link is formed between the two objects, the former object becomes the transmission point, and the latter object the reception point. A ray path searching structure generated by the generation unit 140 of the apparatus for analyzing radio wave propagation in accordance with an embodiment of the present invention will now be described in more detail with reference to FIG. 3.

FIG. 3 illustrates a ray path searching structure generated by an apparatus for analyzing radio wave propagation in a radio wave system in accordance with an embodiment of the present invention. Specifically, FIG. 3 illustrates an exemplary ray path searching structure generated using an IVS 200 constructed by the construction unit 120 illustrated in FIG. 2.

Referring to FIG. 3, after the construction unit 120 of the apparatus for analyzing radio wave propagation constructs an IVS 200 as a radio wave propagation model for analyzing and predicting the radio wave propagation environment as illustrated in FIG. 2, the generation unit 140 generates a ray path searching structure 300 using the IVS 200. Specifically, the generation unit 140 generates a ray path searching structure 300 by considering a transmission point 302 and reception points 310, 312, 314, and 316, which are determined by viewing at respective objects, e.g. objects A to I 320, . . . , 336, in the IVS 200. In other words, after a transmission point 302 and reception points 310, 312, 314, and 316 are determined in an environment resulting from all objects in the service area, the generation unit 140 generates a ray path searching structure 300 based on visibility with reference to the transmission point, i.e. dynamic visibility set links of the IVS 200.

More specifically, the generation unit 140 forms ray paths connecting the transmission point 302 to the reception points 310, 312, 314, and 316 through object A 320 and object B 322, based on visibility with reference to the transmission point 302 in the IVS 200. The generation unit 140 forms ray paths between object A 320 and object C 324 and object D 326 based on the dynamic visibility set link of object A 320, i.e. IVS-A 340, in the IVS 200. The generation unit 140 forms a ray path between object C 324 and object G 332 based on the dynamic visibility set link of object C 324, i.e. IVS-C 344. The object D 324 and object G 332 form ray paths with the reception points 312 and 314.

The generation unit 140 forms ray paths between object B 322 and object E 328 and object F 330 based on the dynamic visibility set link of object B 322, i.e. IVS-B 322, in the IVS 200. The generation unit 140 forms a ray path between object E 328 and object J 224, as illustrated in FIG. 2, based on the dynamic visibility set link of object E 328, i.e. IVS-E 346, and forms a ray path between object F 330 and object I 336 based on the dynamic visibility set link of object F 348, i.e. IVS 348. Object H 334 has no visibility at object E 328, i.e. there is no dynamic visibility set link formed between object E 328 and object H 334, and no ray path is formed based on IVS-E 346. As a result, the object H 324 is removed by frustum-culling with reference to a source, i.e. transmission point or image point, to which a path is to be connected based on the IVS-E 346. Consequently, the object H 334 is connected by no ray path. The object I 326 forms a ray path with the reception point 316.

As such, the generation unit 140 generates a ray path searching structure 300 by connecting the transmission point 302 with respective objects and reception points 310, 312, 314, and 316 through ray paths using the IVS 200. In the generated ray path searching structure 300, each object becomes a node; the transmission point 302 becomes a transmission end (Tx); and the reception points 310, 312, 314, and 316 become reception ends (Rx). The transmission end, nodes, and reception ends are connected by ray paths. Specifically, there are direction connections between the transmission point 302 and the reception point 310, between object G 332 and the reception point 312, object D 326 and the reception point 314, and between object I 336 and the reception point 316, respectively. In summary, the generation unit 140 connects the transmission end and the reception ends through the ray paths, using each object as a node, based on the dynamic visibility set links at respective objects.

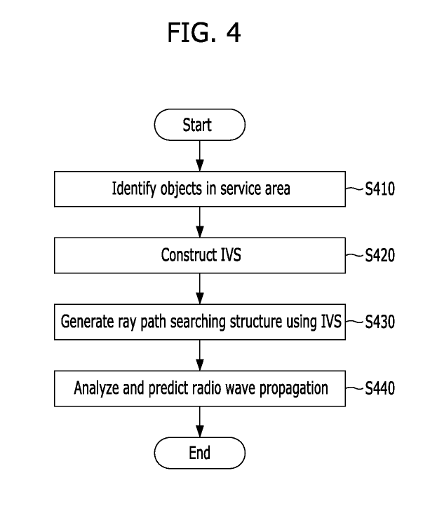

After the generation unit 140 generates a ray path searching structure 300 by connecting the transmission point 302, respective objects, and the reception points 310, 312, 314, and 316 through ray paths using the IVS 200 as illustrated in FIG. 3, the analysis unit 150 analyzes and predicts the radio wave propagation environment through backward ray tracing 360 based on the ray path searching structure 300 generated by the generation unit 140. That is, the analysis unit 150 applies the constructed IVS 200 to a ray tracing scheme, specifically, applies it to a 3D ray tracing scheme dynamically, to analyze and predict the radio wave propagation environment. Specifically, the analysis unit 150 applies the constructed IVS 200 to a ray tracing scheme employing ray viewing volume based on an electro-image method, as mentioned above, and analyzes and predict the radio wave propagation environment rapidly and accurately. Operations of analyzing and predicting the radio wave propagation environment (characteristics) by an apparatus for analyzing radio wave propagation in accordance with an embodiment of the present invention will now be described in more detail with reference to FIG. 4.

FIG. 4 illustrates a schematic operation process of an apparatus for analyzing radio wave propagation in a radio wave system in accordance with an embodiment of the present invention.

Referring to FIG. 4, the apparatus for analyzing radio wave propagation detects and identifies all objects, i.e. structures related with actual topography and buildings existing in a service area where users are provided with various types of services at step S410.

The apparatus for analyzing radio wave propagation calculates the relative position between all of the identified objects and constructs an IVS based on visibility at respective objects at step S420. Specifically, the apparatus for analyzing radio wave propagation forms dynamic visibility set links of respective objects based on visibility at respective objects, i.e. visibility meaning that when viewing, from a surface of an object, a surface of another object, a part or entire surface of the latter object is directly visible, as mentioned above, and constructs an IVS based on the formed dynamic visibility set links of respective objects.

The apparatus for analyzing radio wave propagation generates a ray path searching structure using the constructed IVS at step S430. Specifically, the apparatus for analyzing radio wave propagation generates a ray path searching structure by forming ray paths between the transmission point, respective objects, and the reception points based on the dynamic visibility set links at respective objects in the constructed IVS.

The apparatus for analyzing radio wave propagation analyzes and predicts the radio wave propagation environment through backward ray tracing 360 based on the generated ray path searching structure at step S440. That is, the apparatus for analyzing radio wave propagation applies the constructed IVS to a ray tracing scheme, specifically applies it to a 3D ray tracing scheme dynamically, to analyze and predict the radio wave propagation environment. Specifically, the apparatus for analyzing radio wave propagation applies the constructed IVS to a ray tracing scheme employing a ray viewing volume based on an electro-image method and analyzes and predicts the radio wave propagation environment.

In accordance with the exemplary embodiments of the present invention, a radio wave propagation model is acquired based on visibility between objects (structures) in a radio wave system while minimizing the degree of complexity and the amount of calculation. The acquired radio wave propagation model, i.e. inter-object visibility set, is applied to a ray tracing scheme, which can be used efficiently to analyze and predict the radio wave propagation environment rapidly and accurately.

While the present invention has been described with respect to the specific embodiments, it will be apparent to those skilled in the art that various changes and modifications may be made without departing from the spirit and scope of the invention as defined in the following claims.

What is claimed is:

1. An apparatus for analyzing radio wave propagation in a radio wave system, comprising:
an identification unit configured to search and identify all objects existing in a service area in which users are provided with services;
a construction unit configured to calculate a relative position between the identified objects and acquire a radio wave propagation model based on visibility at respective objects; and
an analysis unit configured to apply the radio wave propagation model to ray tracing dynamically and analyze radio wave propagation in the service area.

2. The apparatus of claim 1, wherein the construction unit is configured to construct an inter-object visibility set by forming a dynamic visibility set link at respective objects based on the visibility at respective objects and acquire the radio wave propagation model based on the inter-object visibility set.

3. The apparatus of claim 2, wherein the construction unit is configured to view, from a surface of an object among the identified objects, a surface of a different object and, when the surface of the different object is directly visible, form the dynamic visibility set link between the two objects.

4. The apparatus of claim 2, further comprising a generation unit configured to generate a ray path searching structure by forming a ray path between respective objects using the inter-object visibility set.

5. The apparatus of claim 4, wherein the generation unit is configured to connect a transmission end and a reception end through the ray path using respective objects as nodes based on the dynamic visibility set link at respective objects.

6. The apparatus of claim 5, wherein the generation unit is configured to remove, by frustum-culling, an object not connected by the ray path among the identified objects based on the dynamic visibility set link.

7. The apparatus of claim 4, wherein the analysis unit is configured to analyze the radio wave propagation through backward ray tracing based on the ray path searching structure.

8. The apparatus of claim 2, wherein the analysis unit is configured to analyze the radio wave propagation by applying the inter-object visibility set to ray tracing using a ray viewing volume based on an electro-image method.

9. A method for analyzing radio wave propagation in a radio wave system, comprising:
searching and identifying all objects existing in a service area in which users are provided with services;
calculating a relative position between the identified objects and constructing an inter-object visibility set as a radio wave propagation model based on visibility at respective objects;
generating a ray path searching structure by forming a ray path between respective objects using the inter-object visibility set; and
analyzing the radio wave propagation in the service area by applying the radio wave propagation model dynamically to ray tracing through backward ray tracing based on the ray path searching structure.

10. The method of claim 9, wherein in said calculating a relative position between the identified objects and constructing an inter-object visibility set as a radio wave propagation model based on visibility at respective objects,
the inter-object visibility set is constructed by forming a dynamic visibility set link at respective objects based on visibility at respective objects.

11. The method of claim 10, wherein said calculating a relative position between the identified objects and constructing an inter-object visibility set as a radio wave propagation model based on visibility at respective objects comprises:
viewing, from a surface of an object among the identified objects, a surface of a different object and, when the surface of the different object is directly visible, forming the dynamic visibility set link between the two objects.

12. The method of claim 10, wherein in said generating a ray path searching structure by forming a ray path between respective objects using the inter-object visibility set,
a transmission end and a reception end are connected through the ray path using respective objects as nodes based on the dynamic visibility set link at respective objects.

13. The method of claim 12, wherein in said generating a ray path searching structure by forming a ray path between respective objects using the inter-object visibility set,
an object not connected by the ray path among the identified objects is removed, by frustum-culling, based on the dynamic visibility set link.

14. The method of claim 9, wherein in said analyzing the radio wave propagation in the service area by applying the radio wave propagation model dynamically to ray tracing through backward ray tracing based on the ray path searching structure,
the radio wave propagation is analyzed by applying the inter-object visibility set to ray tracing using a ray viewing volume based on an electro-image method.
